(19) United States
(12) Patent Application Publication
(10) Pub. No.: US 2002/0062322 A1
(43) Pub. Date: May 23, 2002

(54) System for the automated carrying out of transactions by means of active identity management

(76) Inventors: Riccardo Genghini, Milano (IT); Andreas Pfitzmann, Dresden (DE); Marit Kohntopp, Kiel (DE)

Correspondence Address: SCULLY, SCOTT, MURPHY & PRESSER, 400 Garden City Plaza, Garden City, NY, 11530, US

(21) Appl. No.: 10/010,878

(22) Filed: Nov. 8, 2001

(30) Foreign Application Priority Data
Nov. 21, 2000 (EP) 00 125 489.5

(51) Int. Cl. G06F 15/00

(52) U.S. Cl. 707/500

(57) ABSTRACT

The present invention relates to the automated carrying out of transactions or conclusions of contracts between contracting parties (A, B) in a communications network, such as for example the internet I. In particular there are described the necessary digital documents (D) for such an automated procedure, data processing devices (C) for assuming witness functions, data processing devices (P) for assuming guarantee functions, and computer software to be installed on corresponding computers for the carrying out of such transactions and conclusions of contracts. A significant element of the automated carrying out of transactions or conclusions of contracts in accordance with the invention is a digital document (D) having a document format with standardized fields for the indication of identities of the contracting parties (A, B) and for the indication of contractual modalities, whereby the fields consist of a standardized field descriptor and at least one value allowed for this field descriptor, so that on the basis of digital signatures (S) an automated carrying out of transactions or conclusion of contracts is possible. By means of such a digital document having a standardized document format, customer and supplier can agree contracts in the internet in principle on an equal basis.

The present invention relates in general to a system for the automated carrying out of transactions or concluding of contracts in a communications network, such as for example the internet, between contracting parties, who explicitly authenticate themselves by means of dynamic digital (possibly pseudonymous) identities. In particular the present invention relates to the elements necessary for such a system, such as digital documents, data processing devices for assuming witnessing functions upon the carrying out of such transactions, such as for example proxy servers, data processing devices for assuming guarantee functions and other services in the case of such transactions, and computer software for carrying out such transactions on the computers of the individual contracting parties, in particular of the customer and of the supplier.

Definitions of terms relating to identity:

1. True identity: all information which relates to a subject, including legal identification data, pseudonyms, attributes, identity attributes and so on. One can describe sub-sets thereof as information, attributes or identity attributes.

2. Legal identity: legal identification data which relates to a subject (under the legislation concerning digital signatures, pseudonyms may also be legal identities, in so far as they have the characteristics required in that legislation).

3. Pseudonymous identity: pseudonyms, if applicable with additional information, attributes, identity attributes and so on. Pseudonymous identities may also be legal identities, insofar as this is provided for by law.

Today it is technically possible to interact in a legally binding manner with persons who one does not personally know. However, on the one hand the mutually certain identification of the contracting parties and on the other hand the legally certain configuration of the contract negotiations and conclusion of the contract or of the transaction, which in personal off-line relationships are strongly influenced in their content by the kind of identification and by the attributes associated with the identity, so-called identity attributes, are problematic. With electronic commerce it is thereby particularly problematic that the one contracting party cannot reliably determine the legal identity of the other contracting party. In contrast to personal contract negotiations or transactions, in which the contracting parties meet in person, and can clearly identify each other on the basis of appearance, speech, identity documentation etc., commerce via a communications network, such as for example the internet, offers no clear possibility of identification (unless the party to be identified desires to be identified and the necessary technological and in particular cryptographic infrastructure for identification is available). Each person may be clearly characterized by their DNA, but the security of an online legal relationship would not be increased by such a possibility of identification. The reason for this lies in that identity is not a functional term. It is not sufficient to guarantee the uniqueness of an identity but it is a question of providing the identity with a meaningfulness which is suitable for one or more functions or purposes. In the normal (off-line) world a person cannot normally free themselves from their biometric features and is thus uniquely identifiable, which in many cases is a significant precondition for the legal certainty of transactions and conclusions of contracts.

In contrast, in online relationships the legal identity of physical persons cannot be determined without qualified signature certificates. The definitions of identity and identification procedures employed today in administrative law for physical persons are suitable for the world of personal relationships, not however for the dimension of online relationships. Also the identification of legal personalities is always concerned with a final condition relating to the liability (that is, identification) of the individual persons involved in the legal personality: legal persons act by definition through third parties, i.e. indirectly; for this reason the dimension of liability (from a legal, that is functional, view) is essential for a definition of identity. Generalizing, one can thus say that the legal function of identification lies in the personal liability. Thus, it is in particular likewise possible that a person appears and acts in legal binding manner under a pseudonymous identity instead of under their non-pseudonymous identity.

However it is problematic that—even if the legal identity could be determined online—it would not have the same or a comparable functional meaningfulness that it contains in offline relationships. This is because a locational context of the (legal) dealing is missing: at a physical location, personal presence has an informative guarantee function, which in online relationships is simply absent (guarantee function of the kind of identification, geographical proximity, personal knowledge, membership of a particular human group etc.). Online, the legal identity of persons needs a categorization in order to retain the same functionality that it represents in off-line relationships. This categorization can be different and dynamic only subjectively, and must therefore sensibly be carried out personally.

Biometric features are, in the case of legal relationships in electronic communications network such as for example in the internet, no reliable possibility of identification, insofar as they are processed by insecure hardware and software. On the contrary, the storability and duplicability can bring about a great insecurity and non-verifiability in legal relationships. A person who is personally present and recognizable is neither duplicable nor reproducible. Thus, the safest path for a legally binding conclusion of a contract is the personal presence of the contracting parties. If identification features of a person in digital format are stored by means of insecure hardware or software, innumerable duplicates and reproductions of the original are possible. Such identification features can thus serve for a reliable identification only in secure environments and secure hardware and secure software.

Digital signatures can evidence the integrity, but not directly the authenticity, of the signed object, insofar as they are not reliably activated by means of unique biometric features. In order to determine the real origin of (signed) documents, there can however be employed certificates which are, it could be said, electronic attestations with which signature check data of a digital signature is associated with a legal identity, i.e. with a natural or legal person, and with which the legal identity of this person is confirmed. The issuers of such qualified certificates in accordance with signature legislation are consequently subject to higher requirements in relation to the security and the dependability of the identification and of the management of the identification data. This, however, can not and should not replace the identification and context evaluation activities which the negotiating parties normally carry out directly, in accordance with their own, not necessarily formalized criteria and requirements (also in relation to the necessary degree of care from their point of view).

With the above-described known possibilities for carrying out transactions, or concluding contracts, in a communications network, the readiness of a contracting party to conclude a contract with the other contracting party is thus as a rule dependent upon the acceptance or the trust in the possibly not certified or only partly certified identity of the respective other contracting party. An automated carrying out of transactions and conclusions of contracts is thus possible only to a very restricted extent.

The object of the present invention is to make possible automated carrying out of the conclusion of contracts or transactions between contracting parties in a communications network, in efficient, flexible and despite this secure manner with the aid of a technical infrastructure which can register the dynamic of the identity and bring it into connection also with attributes (in the form of signed references). The automation should be possible not only in the server version of the computer software but also in the client version, so that the normal terms of business of the user can be applied.

The above object is achieved by means of a digital document, in particular a contract, for transactions or conclusions of contracts between contracting parties in a communications network in accordance with claim 1. The digital document is, in accordance with the present invention, realized in a document format having standardized fields for indicating the identities of the contracting parties and for indicating the modalities or terms of the contract. These fields consist in each case of a standardized field descriptor and at least one value allowed for this field descriptor, so that on the basis of digital signatures an automated carrying through of transactions or conclusion of contracts is possible. As value for the field descriptor there may be allowed in general also references to other data structures or null values. Building up on the document format, the management of kinds of identification, and identity attributes and other attributes can be effected transparently.

Advantageously there are provided further fields for indicating the legal status of the contracting parties, for indicating the contractual rights and duties of the contracting parties, for indicating methods of payment, for indicating presentation or safe keeping responsibilities and/or for indicating circumstances attendant to the contract. The fields for indicating circumstances attendant to the contract may thereby include a field for indicating documents or data related to the coming into existence of the digital document or contract. The field for indicating the contractual rights and duties may include a list of the contractual rights and duties of the contracting parties, or a reference to a further document which contains these indications. Further, the field for indicating documents or data related to the coming into existence of the document may include a list of documents or unambiguous references to documents which include these indications.

The nature of identification, and identity attributes and other attributes of the parties, can not only be administered with the aid of the user interface, which is part of the subject of the patent, but also be entered in the subjective evaluation of the respective user, possibly in the standardized fields of the document. This entry is not necessarily formalized.

In accordance with the present invention one or more signatures are present with the digital document. Each digital signature of a contracting party may be additionally certified by means of a certificate. Qualified certificates issued in accordance with this patent contain a reference to a policy setting out consequences of the non-fulfillment of performances agreed in the document. Thereby there may be provided in each case a field for indication of one or more identity features for each contracting party, whereby each such field contains a public digital signature test key of the respective contracting party with an indication of the associated certificate. In the policy there may be defined the conditions under which the legal, (if appropriate, non-pseudonymous) identities of the contracting parties may be revealed. Thereby, the policy can contain a reference to a trustworthy third party which upon occurrence of the appropriate conditions can reveal for one contracting party the identity of another contracting party. The policy can furthermore contain the conditions concerning fulfillment of claims which have not been met, or the provision of equal-valued substitute performances. Thereby, the policy may contain a reference to the trustworthy third party which upon occurrence of the circumstances concerned fulfils the open claims of one contracting party against another contracting party, or performs equal value substitute services. Advantageously, the policy contains the indication of a document format, so that the certificate is only valid when the digital document conforms to the indicated document format. Here, the indication of the document format may contain a format description which defines the standardized fields of the document format and provides them with an unambiguous significance. Thereby, the format description may define a field with a reference to further format descriptions, which determine further valid fields for the document format.

The digital document in accordance with the present invention, in particular by means of the document format having the standardized fields, makes it certain that in each contractual document of electronic commerce a reference to legally binding conditions is clearly recognizable. Some of these conditions should be so characterized that they can be evaluated and checked automatically by means of corresponding IT systems in their given formulation and forms. The structure of the digital document of the present invention is based preferably on XML. During the carrying out of the negotiation of a contractual agreement or a transaction there are created at the contracting parties corresponding digital documents in a standardized, partially machine interpretable format, whereby each contracting party is put in the position for himself, in the case of need, for example if a party does not fulfil his responsibilities, to check and prove the course of the transaction, the concluded contracts, and all preceding circumstances attendant to the contract, for example product descriptions or conditions of business.

The digital document in accordance with the invention thus makes available, for all possible contractual conditions and mutual responsibilities of an electronic negotiation of a contract, a standardized format which makes possible a machine generation and analysis of corresponding contracts in an automated manner to a wide extent, to the extent that they correspond with unambiguous legal language and legal usages. Further, it is made possible for one or more third parties automatically to decide upon the fulfillment or non-fulfillment of the contractual obligations, also taking into account the kind of identification characterized in the document and the identity attributes and other attributes contained in the document. The present invention is the best suitable possibility for dealing with the identity attributes in legal relationships. The term “person with limited liability” or “limited liability person”—“LLP”—(“Person mit beschraenkter Haftung”—“PmbH”) is a part of the patent and indicates the circumstance that even a person only virtually identified can functionally be seen as such when there is linked with this person a liability which can be enforced online (such a virtually enforceable liability may only be limited and object related).

By means of such a digital document, having a standardized document format, for the first time customers and suppliers can conclude in the internet contracts really fundamentally on a basis of equality, since the contractual freedom of the customer is thus not restricted to either completely accepting or completely rejecting a pre-prepared contract of the supplier, and since the contracting parties can by means of the digital contract document, if applicable, refer to contextual or identity information. Since all negotiating parties are always influenced by the context of the negotiation, in particular by the kind of identification and the subjectively perceived (identity) attributes of the other party, the subject of the patent will register all these aspects for all parties and within (or in preparation for) negotiation will administer them. Rather, the customer is thereby in the position to alter the contract in accordance with his wishes and to offer this to the supplier. By means of the standardized form of the contract, the software on the computer of the internet supplier can automatically analyze the contract and decide upon agreement, modification, or rejection.

The standardized documents and the negotiation contexts may be stored in the data processing devices of the parties involved and later take part in further evaluations. This can not only contribute to preservation of evidence as documentation of the conclusions of contracts or transactions, but it is likewise possible therewith to support the parties in identity management for the respective legal relationship concerned. There belongs to this the fact that the parties may deliberately appear under the same pseudonymous identity in order to be able to establish a link to an already created context. With the aid of databanks in which the contents and the context are stored, the knowledge of the negotiating partners obtained in previous legal relationships can furthermore be evaluated and visualized. By means of the transparency which is promoted in this manner the customers can for example consciously make use of their right of informational self-determination. In an evaluation and visualization of the knowledge which the negotiating partners have of one another there may flow also additional information which does not originate from the online legal relationship. Such information can be entered by the respective party in the available data structures or be imported from other sources, for example from information services made available by trustworthy third parties as “privacy services”. Along with the import function there is also provided an export function, so that the parties can pass on the information for import by others who have similar requirements. The same applies to the configuration of the system, which is in fact independent of the contents, for example the security settings or the interpretation rules for the data.

The above object of providing trustworthy legal documentation can also be achieved, insofar as the parties prefer to act or negotiate without qualified signatures, by means of a data processing device, in particular a proxy server, which assumes witnessing functions in the automated carrying out of transactions or conclusion of contracts between contracting parties in a communications network, for example the internet, wherein the data processing device is configured for the automated receipt, intermediate storage and passing on of digital documents as they are defined above. The data processing device for assuming witnessing functions in accordance with the present invention thereby fulfils the function of an electronic witness who monitors a transaction developing in an automated manner between two contracting parties. This offers the same contextual security which up to now could only be achieved by means of the interaction of witnesses and a common place of negotiation. Thereby it is made possible even for contracting parties which come into contact with one another by means of digital documents, without a respective digital signature of the contracting party, to produce trustworthy documentation with the documents intermediately stored and signed by the data processing device, for example in that the completeness of the signed information/contracts and context information can be witnessed. Advantageously, the data processing device which assumes the witnessing function provides the digital documents received from the contracting parties with a time stamp before they are intermediately stored or passed on to the respective other contracting party. If no digital signatures for the contract documents are used by the contracting parties, the data processing device in accordance with the invention can advantageously digitally sign the received documents, so that a reliable protocolling and checking of the contract conclusion is made possible. Thereby, the data processing device in accordance with the invention can digitally sign a document received from one contracting party, pass it on to the other contracting party and intermediately store it at least until the reception of a confirmatory acknowledgement of receipt. For the case that digital signatures for the documents are used by the contracting parties, the data processing device in accordance with the invention can pass on a document, received from one contracting party and provided with a digital signature, to the other contracting party without the digital signature, whereby only after receipt of the document from the other contracting party, together with digital signature, is the digitally signed document from the one and from the other contracting party sent back to the two contracting parties. In order to avoid unnecessarily intensive handling of person-related data, it is of advantage to work only with encrypted data (for example encrypted by means of SSL, in order also to be able to prove the integrity of protocolling) and to sign the data in encrypted form or sign its hash value.

By means of this data processing device for assuming witnessing functions, which can for example be realized as a proxy server in the internet, the legal certainty of the digital documents exchanged between contracting parties can be significantly increased.

Further, the above object is achieved by means of a data processing device for assuming guarantee functions in the case of automated transactions or conclusions of contracts between contracting parties in a communications network with the employment of digital documents as they are defined above. The data processing device for assuming guarantee functions in accordance with the invention provides, in dependence upon the conditions laid down in a digital document, guaranteed performance. The guaranteed performance may thereby relate for example to the fulfillment of conditions laid down in a contract, or also to the non-fulfillment of conditions agreed in a contract. The data processing device assuming guarantee functions is formed for example as a server of a guaranteeing party in the communications network, such as for example in the internet.

By means of the intermediation of a data processing device for the automated carrying out of transactions in accordance with the invention it is attained that none of the contracting parties can achieve an advantage from incorrect behaviour. Such a data processing device is for example realized as a server of a corresponding operator. The operator or operators may for example be one (or, if applicable, more) trustworthy third parties, such as a bank, insurance company, a delivery concern employed for transporting the products the subject of the contract, a time-stamp service, if applicable with additional notarial functions, an information storage service, a telecommunications concern or also a company, professional or consumer grouping. A further task of trustworthy third parties can be the delivery of certain “privacy services”, which for example consist in making available suitable configurations files for import (for example security settings, rules of interpretation) or in making available information services, the contents of which can be stored in data banks by the contracting parties for the purpose of automated evaluation.

The data processing device for assuming guarantee functions in accordance with the present invention includes advantageously, if applicable, also a certification means for issuing certificates for pseudonymous identities, whereby each certificate contains a policy, or a reference to a policy, setting out consequences in the case of non-fulfillment of performances agreed in a contract. In this way new pseudonymous identities, or the associated certificates, can be provided which can be immediately employed in the context concerned. Further, there may also be provided an identity administration means for administering not only (in particular legal) identities, that is pseudonymous and non-pseudonymous identities, but also of person-related information, attributes or identity attributes (or also information about identification procedures). Thereby, the identity administration means can make known the legal (non-pseudonymous) identity of a contracting party in dependence upon the non-fulfillment of performances laid down in a contract with regard to the other contracting party. Alternatively, the identity administration means can, for a pseudonymous or non-pseudonymous identity of one contracting party, guarantee the contractually agreed provision of a particular sum of money with respect to the other contracting party. Instead of the legal pseudonymous or non-pseudonymous identity of a contracting party, in this case there is provided the contractually agreed amount of money or payment. The identity administration means can thereby, instead of the indication of an identity a contracting party, sign for the presence of a particular sum of money in a contract. This corresponds to the real case of the personal but anonymous purchase of an object against payment of a sum of money in cash.

The data processing device for assuming guarantee functions in automated transactions between contracting parties in accordance with the invention thus makes possible on the basis of the guarantee of this trustworthy third party or third parties an efficient automated conclusion of a contract between contracting parties in a communications network. This can, in dependence upon the respective configuration of the guarantee data processing device, be effected either through this third party accepting responsibility for duties to be fulfilled, or through accepting responsibility for non-fulfilled duties concerning promised performances, in an automated manner, without there being necessary therefor a court decision or the like. The data processing means for assuming guarantee functions may thereby be differently configured and may for example also offer an online arbitration function, an insurance function, a performance guarantee function etc.

The present invention relates further to computer software, for implementation on an data processing device associated therewith, for automated transactions or conclusions of contracts between contracting parties in a communications network, such as for example the internet, on the basis of the digital documents defined above and the above-defined dynamic digital identities, kinds of identification, and identity attributes and other attributes. The computer software in accordance with the invention is so configured that when it is installed on a data processing device of a contracting party of the communications network, such digital documents are automatically produced, if applicable signed, and sent to another contracting party. Thereby, the computer software in accordance with the invention automatically checks a document received from a contracting party, if appropriate alters it, also taking into consideration the above-mentioned dynamic digital identities, kinds of identification and identity attributes and other attributes, and sends it back to the contracting party. The computer software in accordance with the invention with associated data processing means is advantageously installed on a data processing device, that is a computer, of one contracting party, for example a customer or a supplier. The computer software in accordance with the invention makes possible further advantageously the dynamic administration of identity attributes, kinds of identifications and further attributes which are related to a person (physical/legal), if applicable with a qualified certificate. Thereby, the identity attribute administration allows deductions about the authority to carry out a transaction of one's own profile or of the profile of another person. The software in accordance with the invention, in its server version, supports an increased automation of the procedures, in particular as relevant to the transactional legitimacy of third parties. The computer software in accordance with the invention further makes possible advantageously the administration of the personal profiles made available to third parties, in particular in the form in that through individual use certificates the person whose data is captured in a profile (or if applicable another owner of the profile) receives a fee from the profile users/processors. Correction and deletion of this profile should be capable of being automatically requested and checked by the profile users/processors. The computer software in accordance with the invention further makes available advantageously a shopping basket for routine purchases on the basis of digital documents or contracts together and administers these. Further, the software in accordance with the invention can administer general terms of business. In the server version, the software can administer both one's own general terms of business and also the general terms of business of customers who come into contact with the server. In the customer version or client version, the software can administer one's own general terms of business and link them to specific transactions. Further, the computer software in accordance with the invention makes it possible to keep a log or a list of transactions carried out, including signed witnessing certificates and personal profiles made available to third parties.

In particular the intermediation of a data processing device for assuming guarantee functions makes it possible for the present invention to provide an increased security for participants or contracting parties in open communication networks, since a private contracting party need not transmit any sensitive (payment) information to a professional contracting party (supplier, service provider etc.) and if desired can remain anonymous with respect to the other contracting parties by means of the employment of suitable digital pseudonymous identities. In order nonetheless to make it possible for the professional contracting parties in open networks to have increased customer loyalty the individual customer can make himself known with respect to the supplier under the same pseudonymous identity in a manner which cannot be falsified.

The invention can, by means of a corresponding realization of the data processing device in the case of consumers and data processing parties, assume the additional function of a so-called individual use certificate. With the aid of such an individual use certificate the person concerned can be informed in detail of each capture, use or transfer of his person-related data (or also data which it may be possible to relate to his person), inclusive of the employed pseudonymous identities and (identity) attributes. The sending of an individual use certificate may be contractually agreed within or before the respective data processing. Therewith there can be determined also restrictions or extensions, for example a restriction of the purposes for which the person concerned will allow the data to be data processed, and the kind and extent of possible credits (money or money-like bonus points). The computer software can receive the individual use certificate messages arriving via the communications network and automatically evaluate them, so that the information desired by the person concerned is displayed or so that the person concerned can be interactively questioned, for example concerning the release for a data processing activity desired by the data processing party. In the case of agreed payments, the user interface of the computer software can visualize this by means of an increasing “credit ticker”.

In summary, the possibility provided by the invention for the automated carrying through of transactions in a communications network represents, for any contracting party, an advantageous, legally secure and synergetic combination of multifaceted security, transparency of systems and business processes, and the protection of data.

The present invention will described in more detail in the following description with reference to preferred exemplary embodiments and with reference to the drawings, in which there is shown:

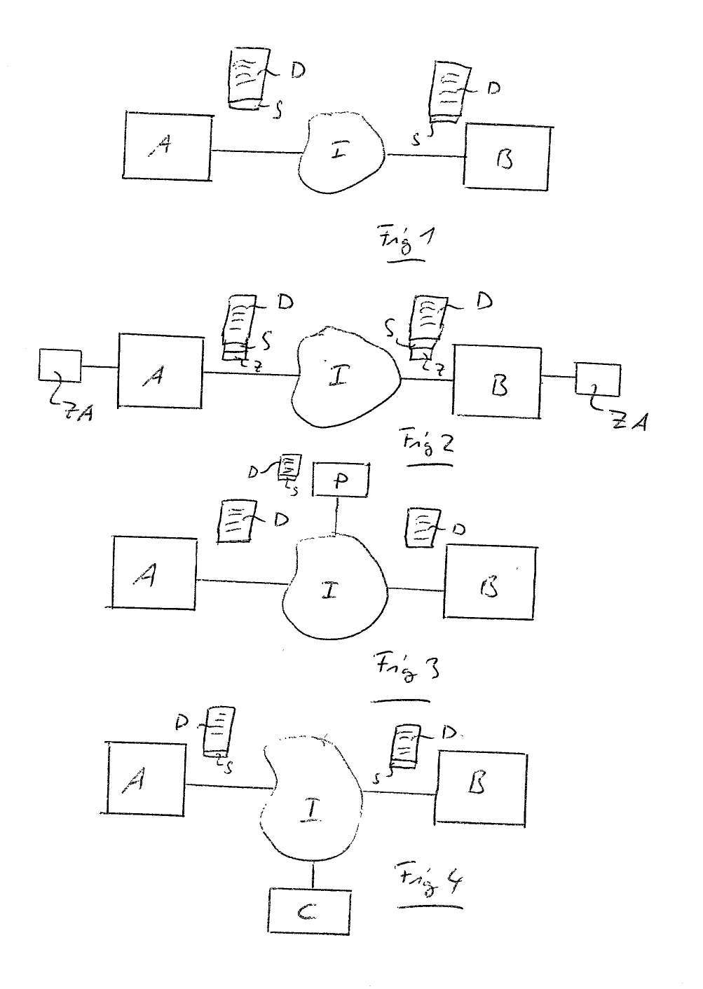

FIG. 1 a schematic representation of a first exemplary embodiment for automated carrying out of transactions between two contracting parties via the internet,

FIG. 2 a schematic representation of a second exemplary embodiment for automated carrying out of transactions via the internet,

FIG. 3 a schematic representation of a third exemplary embodiment for automated carrying out of transactions between two contracting parties via the internet, and

FIG. 4 a schematic representation of a fourth exemplary embodiment for an automated carrying out of transactions between two contracting parties via the internet.

FIG. 1 shows a schematic illustration of a first exemplary embodiment for a system for carrying out transactions or concluding contracts in accordance with the present invention. A first contracting party A wishes to carry out a transaction or conclude a contract with a second contracting party B via a communications network, such as in the present case the internet I. The contracting party A is for example a customer, and the contracting party B is for example a supplier of goods, services or the like. The contracting party B thereby presents for example its offers on a website. This website is stored on a server of the contracting party B and can be called up by means of a computer of the contracting party A through the calling up of the corresponding associated internet address and can be downloaded for viewing. The contracting party A now seeks from the offers made by the contracting party B one or more products and sends a corresponding offer for the conclusion of a purchase contract via the internet I to the contracting party B.

In accordance with the invention there is thereby employed by the contracting party A a digital document D having a special document format. For example, this document format is downloaded together with the offering website of the contracting party B onto the computer of the contracting party A. On the computer of contracting party A, a digital document, that is a offer of a contract, is produced by filling in standard fields in the document format provided, and the digital document is transmitted to the contracting party B. The document format having the standardized fields makes it certain that in each digital document produced a reference to legally binding conditions is clearly recognizable and that these conditions and indications can be automatically evaluated and checked at the receiving side, in the present example by means of the server of contracting party B, or by means of the computer software installed on the server. Advantageously, the structure of the employed digital document D is based on the XML format.

The standardized fields of the document format for the digital document D include fields for indicating identities and/or (identity) attributes of the contracting parties and for indicating the contract modalities or terms. The fields each consist of a standardized field descriptor and at least one value permitted for this field descriptor, so that on the basis of digital signatures S an automated carrying out of transactions and conclusions of contracts is made possible. In the example shown in FIG. 1, contracting party A transfers a digital document D with the indication of a possibly pseudonymous identity, and with the indication of further contractual conditions, together with his digital signature S via the internet I to the server of the contracting party B. There, the digital document D is received, checked and evaluated. The evaluation concerns on the one hand the contractual conditions indicated in the standardized fields; that is, it is checked whether the offer issued by contracting party A is at all acceptable with regard to its contractual contents. Further, the possibly pseudonymous identity of contracting party A, together with the digital signature S, is checked and evaluated. This means that the contracting party B, similarly as with the conclusion of contracts between people who are personally present, must evaluate the possibility pseudonymous identity and the digital signature of the contracting party A in order to decide whether this possibly pseudonymous identity can be considered sufficiently trustworthy for the conclusion of this particular contract. By means of the employment in accordance with the invention of the standardized fields for the document format there is thereby made possible an automated electronic checking and evaluation and thus carrying through of the transaction or contract negotiation. This means that the contracting party B need not personally check and evaluate the indications in digital document D which comes from contracting party A, but that the server of contracting party B can check and evaluate the indications in the standardized fields of the digital document D, together with the possibly pseudonymous identity of the contracting party A, and decide whether to accept or reject the offered contract or to issue a modified contract offer. This procedure is advantageously configurable in detail and dynamically administrable, also by means of the definition of action parameters which can be set subjectively for the identity, the kind of identification and (identity) attributes.

In the case of an alteration of the contractual offer, the server of contracting party B automatically sends a modified digital document D, if applicable with a digital signature S of contracting party B, via the internet back to the contracting party A, that is to his computer. If the contracting party B is a professional supplier of goods, services or the like in the internet, it may not be necessary that a modified contractual offer of contracting party B is sent back to the contracting party A with a digital signature. In this case, the legal identity of the contracting party is known to contracting party A, at least if the contracting party B is a medium or large undertaking and the authenticity of the associated web presence or of the digital communications partner is ensured. If contracting party B is, however, a small undertaking or a private person, as a rule the contracting party A will have a particular interest in checking the legal (pseudonymous or non-pseudonymous) identity of contracting party B. As with the server or the computer of the contracting party B, the computer of contracting party A, or the software installed on this computer, will thus also have corresponding functionality for the administration of legal pseudonymous or non-pseudonymous identities of other contracting parties and if applicable corresponding identity attributes, for the assessment of the reliability of these identities. The data processing devices make it possible, from the kind of identification, from the contextual conditions, and from the identity attributes or other attributes, to define authorized negotiation or contract conclusion processes, and also contractual contents. Since such process definitions are very complex, in particular from a semantics point of view, the patented method will make possible the active progressive administration of the process definition.

In the simple case illustrated in FIG. 1, a transaction or a conclusion of a contract takes place on the basis of digital documents D which are each provided with a digital signature S of the contracting parties A, B. The authenticity of the employed pseudonymous or non-pseudonymous identities and of the digital signatures S is assessed in the computers or servers of the contracting parties A and B in an automated manner on the basis of pre-defined evaluation criteria, for example on the basis of the kind of identification and identity attributes or other attributes. For example identities with which successful transactions or contracts have already previously being carried through are assessed as very reliable (“positive attribute evaluation”), whilst identities which are unknown are assessed as less reliable. This evaluation of the reliability of the identity of the other contracting party may be effected for example also in dependence upon the subject of the contract or the value of the contract.

For increasing the contractual or legal security the digital signatures (or digital signature test keys) S may be certified by means of additional qualified certificates Z. These may be X.509 certificates or also otherwise formalized text documents. This case is schematically represented in FIG. 2. The second exemplary embodiment illustrated in FIG. 2 corresponds to the exemplary embodiment illustrated in FIG. 1, whereby additionally a certificate Z for each digital signature S of the contracting parties A and B is employed.

Normally, to each digital document D produced by one of the contracting parties A and B, in addition to the digital signature S of the respective contracting party, there is additionally attached a certificate Z which ensures the authenticity of the digital signature and thus of the legal pseudonymous or non-pseudonymous identity of the respective contracting party A, B, when there is involved here a qualified certificate according to 1999/93/EG. In the case illustrated in FIG. 2, each contracting party A, B receives the qualified certificate Z issued by a certificate issuer ZA. Thereby, in each case different certificate issuers may be used, or one and the same certificate issuer. Qualified certificates have however, in accordance with existing standards and governmental regulations, only an insufficient part of the information which is necessary to configure online transactions with the same legal certainty as anonymous or pseudonymous offline transactions today (for example boutique or supermarket purchases in off-line relationship).

For the automation of the negotiations and also for the bilateralization of the negotiation procedure, further information relating to the contracting parties is necessary. It is not sufficient simply to enter this information in the optional fields of the X.509 standard, since this would require an unacceptable simplification and formalization, so that the meaningfulness of the information about the contracting parties would be destroyed. This information should thus be presented in a formalized document, which is advantageously treated in the transaction as an attribute certificate.

The respective contracting parties A and B must therefore have concluded a contract with the certificate issuer ZA, so that the certificate issuer is in a position with regard to the attributes (such as for example creditworthiness or dependability of the respective contracting parties), either to accept these without checking, through signed references, or to establish these attributes, to decide on these attributes and to certify them correspondingly. If one of the contracting parties A and B wishes to carry out the transaction or conclusion of a contract of the basis of a pseudonymous identity, the certificate issuer issuing the certificate Z must therefore today know the legal non-pseudonymous identity of this contracting party. Alternative to the example illustrated in FIG. 2, the two certificates Z for the digital signatures S of the contracting parties A and B may also be made available by a single certificate issuer.

The third example shown in FIG. 3, and the fourth example shown in FIG. 4, of a scheme for the carrying out of transactions or contractual negotiations between two contracting parties A and B via the internet I by means of digital documents D correspond in the main elements and functionalities to the two examples shown in FIGS. 1 and 2. However, in the third and in the fourth example, a transaction or conclusion of a contract is carried out through a trustworthy third party (for example a marketplace or broker). In the example illustrated in FIG. 3, the trustworthy third party can be connected via the internet I with the two contracting parties A and B and be constituted as a data processing device P, such as for example as proxy server, for the automated carrying out of the transactions or contractual negotiations or conclusions of contracts. The data processing device P of the third example thereby assumes solely the passive function of a witness which intermediately stores, if applicable signs, the documents received from the two contracting parties A and B, and forwards them to the respective other contracting party. Additionally, the data processing device P can number each transmitted digital document D, provide it with the current time and sign this information (time stamp function). In the fourth example, shown in FIG. 4, the trustworthy third party is realized as a data processing device C for assuming guarantee functions and provides, in dependence upon conditions laid down in a digital document D between the contracting parties A and B, certain guaranteed performances. The configuration of the data processing device P of FIG. 3 and the data processing device C of FIG. 4 will be specified in more detail below.

As mentioned above, the present invention puts forward a format for digital documents D and functionalities for computer software for data processing devices, and data processing devices, for the automated carrying out of transactions, contractual negotiations and conclusions of contracts between contracting parties A and B in a communications network, such as for example the internet I. Further, the present invention proposes that functionally relevant data (kind of identification, identity attributes and other attributes etc.) be related to the qualified certificate from A and B, in order also in the case of pseudonymous identity or anonymity to be informed of the actual existence of the respective contracting party, even when that party appears under different or, possibly, always under new identities and/or attributes. The data processing devices are thereby for example computers of the contracting parties A and B, and servers of trustworthy third parties, such as are represented in FIG. 3 by means of the data processing device P and in FIG. 4 by means of the data processing device C. The format of the digital documents D forms the basis for contractual documents arising in the case of such transactions or conclusions of contracts, and ensures the legally certain and legally binding automated carrying out via the internet I. The data processing devices in accordance with the present invention, and the computer software provided for these devices, can unambiguously recognize the digital documents D, or their document format, can interpret these documents and through this evaluate and check them automatically mechanically. Further, due to the proposed document format, new or modified contractual documents can be produced and transferred to the other contracting party.

With the digital document format in accordance with the present invention, employed in particular for electronic contractual documents, special standardized fields are determined. Each field consists of an association of a descriptor and one or more values, whereby as values there may also be employed further field structures or references. In a correspondingly associated format description there is defined each field descriptor corresponding to the standard, together with the values allowed for this field descriptor. A digital document D in accordance with the present invention thereby includes at least in each case a field for indication of the legal pseudonymous or non-pseudonymous identities of the contracting parties A and B and one or more fields for indication of contractual modalities or terms. More precisely, there should be made available fields corresponding to at least some of the following indications:

indications concerning the identity of the parties and their legal status;

indications concerning one or more trustworthy third parties (data processing device P of FIG. 3 or data processing device C of FIG. 4);

indications of parties which can reveal identities (for example data processing device C of FIG. 4) and a reference to a policy which defines the conditions under which a pseudonymous identity of a contracting party A or B can be revealed;

indications concerning the responsibilities and rights of the individual contracting parties A and B, for example mode of payment, payment conditions, delivery conditions etc.

payment information;

circumstances attendant upon the contract, for example lists of documents or other data (or unique characterizations or hash values thereof), which have causally led to the creation of this digital document D;

duties to store, duties to delete, in particular duties to present, the digital document D.

If the digital document D employed is provided with a digital signature S, the digital signature S can thus in each case be certified by means of a (qualified) certificate Z, such as for example is shown in the examples 2 and 4. Advantageously, the certificates (attributes certificates) may contain a policy or a reference to a policy setting out the consequences in the case of non-fulfillment of the conditions agreed in the digital document D, which also may be influenced by the kind of identification and/or by the identity attributes or other attributes. Additionally, the policy describes which document format is permitted to be signed with this digital signature S, in order to ensure a semiotically secure context for the generation of the signature. With this it is ensured that within the scope of the negotiation concerned of legally certain transactions or contracts, digital documents D are only legally valid when they contain the document format indicated in the respective certificate and are seen, understood and signed in the intended context. Further, in order to configure the document format flexibly and expandably, the digital document D may include a standardized passage or a further field wherein reference to expanded document descriptions is provided. Here, it is possible only with the agreement of all contracting parties A and B, to employ any possible format extensions to the description of the contents of the contract. Further, through this checkable standardized passage or the standardized field it is attained that an automatically signing computer of one of the contracting parties A or B only signs a digital document when it recognizes the format extension employed and can evaluate it.

Additionally, there may be provided further fields in the document format which may contain the original data in any other indicated formats, which are relevant for the coming into existence of a contract. By these means the causes of misunderstandings which have arisen in the course of conclusion of the contract can be recognized. The proposed digital document D of the present invention with the standardized document format and format description, to which reference may be made in the document if appropriate, makes possible in particular in the case of application to electronic contracts, a mechanical automated production of such documents on the computers of the contracting parties A and B and a correspondingly automated check analysis under the application of natural, non-formalized language, by means of suitable formalization of the context (in the document, surrounding the document). Further, a trustworthy third party, such as for example by means of the data processing device C of the fourth example shown in FIG. 4, will automatically decide on the fulfillment or non-fulfillment of the contractual conditions defined in a respective digital contractual document D, insofar as this does not require any activity of semantic interpretation. Further, the standardized format makes possible the coverage of corresponding transactions or conclusions of contracts with liability insurance, legal costs insurance or the like, in order in the case of occurrence of conditions defined in each case to obtain guaranteed performances by means of a trustworthy third party, such as for example the data processing device C of FIG. 4. Further, the document format in accordance with the invention makes it possible to make use of an online arbitration, which can have available the relevant transaction information, such as for example the circumstances under which the contract arose and a protocol of the performances carried out, in order in the case of a non-fulfillment or poor fulfillment of a performance defined in a contractual document likewise to exercise automatically an arbitration function.

As already explained above, the legal certainty of the transaction or the conclusion of a contract between two contracting parties A and B, in contrast to the example shown in FIG. 1 and FIG. 2, in which the digital documents D are exchanged directly between the two contracting parties A and B or their computers, the entire communication and transmission of digital documents D belonging to a transaction can be carried out via a trustworthy third party. In the simpler case shown in FIG. 3, the trustworthy third party is for example a data processing device B, such as for example a proxy server, which assumes the functions of an electronic witness. To this there belongs in particular that the data processing device P, in an automated manner, receives, intermediately stores and passes onto the respective other contracting party the digital documents D transmitted from the contracting parties A and B. Additionally, the data processing device P can number each transmitted document D, provide it with the current time, and sign off on this information, and intermediately store the digital document D until the addressed contracting party has confirmed receipt. The document received from a contracting party, and if applicable signed by this contracting party, is thereby sent at the same time to the data processing device P and to the other contracting party, whereby the data processing device P provides the received digital document D with a time stamp, as indicated above, in order to confirm content and time point. The function of the witness cannot directly determine the legal identity of the parties, but it can at least take in all non-active/dynamic contents of websites. Whoever of the parties asserts that a certain transactional development has taken place can in fact prove this on the basis of the documentation signed by the witness. This is in particular also possible when the encryption protocol SSL is employed. Both parties can bind into the transaction information for subsequent authentication, which can only be known to them. The witness (so-called “E-witness”) can be provided solely by means of a proxy server and also by means of a combination of proxy server and software locally installed on the client data processing device.

For additional confirmation of authenticity, the received digital document may, if applicable, together with the time stamp, be digitally signed by the data processing device P. This scheme has however the disadvantage that the first contracting party which sends the digital document D with a digital signature S, must take the risk that the other contracting party provides their digital signature not at all or only at a later time point. In order to prevent this, the data processing device B may for example fulfil one of the following functionalities: in a first configuration of the data processing device P, this first receives the signed contract documents D of the contracting parties A and B confidentially, and only sends the contract signed by all contracting parties back to all contracting parties. If thereby the contract document D is not itself signed, but only a cryptographically unique hash value of the same, the data processing device P or its operator need know nothing of the content of the contract. In a second configuration, the data processing device P receives the signed document D from contracting party A, checks the digital signature S and informs the contracting party B of the content of the correctly signed contract document. If contracting party B accepts the contract, the data processing device P signs the contract on behalf of the contracting party B and sends the digital signed contract to both contracting parties A and B. The digital signature of the data processing device P is thereby valid subject to a policy contained in the contract document D, which the data processing device P determines and which the two contracting parties A and B accept through the choice of the data processing device P.

This procedure is particularly important because a very widespread and repeated employment of the signature also for daily business can bring with it as a consequence a loss of significance (and of warning function) of the signature. With what one would replace the signature in such a case is not clear, since the signature has achieved great significance through two thousand years of legal practice. The signature is thus not easy to replace at the present time. Therefore it is entirely recommended to avoid a too frequent use of the signature. The witness function can readily replace the signature in all contracts which are not bound in form (and is just as strongly legally and socio-culturally founded as signing). Further, the procedure here described has the advantage that some important agreements (such as level of interest payments, particular guarantees etc.) which need the written form, cannot be inadvertently signed (which is a further protection for all participants).

With this procedure one achieves the same goal of trustworthy legal documentation as in the first case explained with reference to FIG. 3, additionally however there is also achieved through the qualified certificates, signatures and signature check units the mutual authentication of the contracting parties.

In FIG. 4 there is illustrated a further scheme for the automated carrying out of a transaction or conclusion of a contract via the internet I between two contracting parties A and B by means of a trustworthy third party. The trustworthy third party of the fourth example shown in FIG. 4 is a data processing device C which is equipped for assuming guarantee functions in the transaction, which independently of the conditions laid down in a digital document D between the two contracting parties A and B can deliver guaranteed performances. In contrast to the third example shown in FIG. 3, in which the data processing device D merely serves a witness function, the data processing device C in the fourth example shown in FIG. 4 takes active part in the transaction or contract negotiation. Although only a single data processing device C is illustrated in FIG. 4, there may be present in each case a corresponding data processing device for each of the contracting parties A and B. With the following, for reasons of simplicity, the process will be described on the basis of a single data processing device C as illustrated.

One of the basic functionalities of the data processing device C is the signing of a digital document D for a contracting party A or B through issuing of a corresponding certificate for the respective identity of the contracting party. For this purpose, the data processing device C includes a corresponding certification mechanism. The identity of the respective contracting party A or B, certified by the data processing device C, is in the example shown in FIG. 4 preferably a pseudonymous identity, whereby the carrying through of the transaction or contract is possible without revelation of the legal (non-pseudonymous) identity of a contracting party. For example, the data processing device C can identify a contracting party A, B instead of by means of a pseudonymous identity, also by means of a bank account or by means of another asset or other liquid or immediately available value, which can be deposited online, such as for example money, other values, such as for example, titles, electronic cash, immediately due credits etc. This certification is particularly meaningful in relation to the creditworthiness of the respective certificate holder. By means of a corresponding configuration of the policy of the data processing device C, contained in each certificate, in which inter alia the consequences of non-fulfillment of performances agreed in a contract are defined, even the legally binding security for the agreed performances may be provided. For example, a contracting party A or B may identify itself completely anonymously by means of a restricted amount of electronic cash or a cash sum. The identity of the contracting party A or B is thereby deleted with the money employed for identification. Alternatively, a contracting party A or B may identify itself by means of access rights to their bank account or other assets available online, as determined in the policy of the certificate: as so-called Pledge Account Identity or “Pfandkontoidentitaet” or also Limited Liability person (LLP) or “Person mit beschraenkter Haftung” (PmbH) [terms which are all subject of the patent], which will be explained in more detail below. Alternatively, the data processing device C can identify contracting party A or B, within the scope of the issuing of a certificate, also by means of an existing or by means of several existing legal relationships, such as for example by means of a contract concluded with the respective suppliers for water, gas or electricity supply and/or by means of corresponding and possibly corresponding configured meters or counting devices, or by means of contracts with telephone or mobile telephone providers. Such an identification is particularly meaningful in relation to the normal location of a contracting party and in Anglo-Saxon legal systems is a widely used method of identification.

With all the above-described identification mechanisms the identities and the certificates are pseudonymous. This means that the contracting party receiving a correspondingly signed and certified document D does not know the offering contracting party. The sole available reference is the issuer of the certificate, that is the operator of the data processing device C. Since the issuer of a certificate in general, at least within the area of the European Union, is legally forbidden to disclose the personal data of a certificate holder, that is a contracting party A or B, without permission, the following models are conceivable for the examples schematically shown in FIG. 4:

1) The data processing device (C) as issuer of the certificate receives from the certificate holders, that is from the contracting parties, the authority in the case of a legal dispute or in the case of particular condition laid down in the contract, to reveal personal information concerning identity with respect to the other contracting party (or to a third party which at the request of the two contracting parties acts as mediator or can carry out defined steps).

2) The data processing device C as issuer of the certificate receives from the certificate holder, that is the contracting party, a permanent non-cancellable authority to access bank accounts or other value available online, in order to carry out a performance laid down in a contract of this contracting party.

3) The data processing device as issuer of the certificate receives a certain quantity of money or titles for the purpose of contract fulfillment or as damages, for safe keeping or administration. The authority may thereby also relate to means of payment for an individual transaction.

4) The data processing device C as issuer of the certificate insures the individual transactions or conclusions of contracts.

5) The data processing device C as issuer of the certificate accepts or guarantees to fulfil certain performances laid down in the transaction or the contract, under particular conditions described in the policy of the certificate.

As a rule, the contracting party which has authorized the service provider having the data processing device C to disclose the identity to others under certain conditions, or to carry out certain defined services, can link this to a requirement that they will be informed about the performance of such activities by the service provider.

If, as in the fourth example shown in FIG. 4 by means of the data processing device C, a digital document D is signed and certified by a trustworthy third party, standing in place of a contracting party A or B, the data processing device C is—in the case that the duties contained in the digital document D are not carried out by the actual contracting party with respect to the other contracting party—in dependence upon the conditions laid down in the policy associated with the certificate, to demonstrate to the other contracting party the legal (non-pseudonymous) identity of the actual contracting party, to fulfil the promised performances or to provide equivalent performances on behalf of the actual contracting party, to provide an equal value for example equal money value substitute, or themselves to fulfil the promised performances.

In the case of the demonstration of the legal (non-pseudonymous) identity of the actual contracting party, the data processing device C must either be able to present the original digital signature of the actual contracting party for the document D concerned, or be able to present a signed declaration from the actual contracting party, which states that the contracting party accepts liability for all duties based on documents which are signed with the pseudonymous identity employed. Additionally, the data processing device C must present a signed document, or at least must be in possession of such a document, from which it is clear that, dependent on the model to be applied, the data processing device C is entitled to disclose the legal non-pseudonymous identity of the actual contracting party in a demonstrable manner, when the conditions defined in the policy are fulfilled, the data processing device C is entitled or authorized to carry out the payment on behalf of the actual contracting party, or the data processing device C has the responsibility to carry out the required performances, substitute performances or damages on behalf of the actual contracting party.

In the following an identification and payment method already briefly mentioned above with the aid of a so-called Pledge Account Identity (“Pfandkontoidentitaet”) or LLP (“PmbH”) will be described, which can be used by the data processing device C in order to make payment procedures legally certain. At the same time the payer cannot be identified by others without authority, or his transactions cannot be linked with one another. In this model, the data processing device C is for example a server of a bank or the like. In this case the data processing device C carries an account in the name of a contracting party A, with which this contracting party A can work as with a normal bank account. Additionally, however, the contracting party A can conclude contracts within the scope of digital documents D under pseudonymous identities which are certified by the data processing device C, whereby the data processing device C settles the responsibilities of the contracting party A arising from these contracts, in place of the contracting party. Thereby, the data processing device C checks on the basis of the contract and on the basis of proof presented, before payment of the amount contractually determined, whether the other contracting party B has fulfilled its responsibilities. Such a proof may be for example, confirmation of delivery by a delivery service or the like.

To security on all sides there belongs further that a contracting party A, so far as they wish, can act anonymously or at least pseudonymously. This is achievable by means of the following measures which relates to all examples explained above with reference to FIGS. 1 to 4:

Anonymization and possibly encryption of the network connection from contracting party A or B with respect to the internet I is required in principle since otherwise a pseudonymization of parties would pointless. For anonymization various methods can be employed in dependence upon with what level of certainty one wishes to be protected from hackers, for example simple intermediate stations, strong anonymization services such as Mixnetz, Mixkaskade, Freedom, etc.

Signatures, which provide no relationship to the identity of a contracting party, certification of the signatures by parties who can either reveal the identity or accept liability for actions of the contracting party or provide guarantee performances of a particular maximum value.

Security against disadvantages or advantages for a pseudonymous/anonymous contracting party by means of many facetted secure transaction models. For example an anonymous contracting party could conclude contracts without accepting liability therefor but then as a rule they cannot take action for breach of contract by the other contracting party, without giving up their anonymity.

Indeterministic, asymmetric encryption of the delivery address for the agreed delivery service. By these means it is achieved that the internet supplier need not receive any person-related data of the customer.

Control and monitoring of a contracting party via their recognizability through other contracting parties by means of free choice of their pseudonymous identity.

It is to be noted that the functionalities of the computers of the contracting parties A and B described above, and of the data processing device P for assuming witness functions in accordance with the example of FIG. 3, and the data processing device C for assuming guarantee functions in accordance with the example of FIG. 4, are carried out automatically by means of computer software. The present invention thus relates also to computer software for carrying out the functionalities concerned on the corresponding computers.

1. Digital document (D), in particular a contract, for transactions or conclusions of contracts between contracting parties in a communications network (I), having a document format with standardized fields for the indication of identities of the contracting parties (A, B) and for the indication of contractual modalities, whereby the fields consist in each case of a standardized field descriptor and at least one allowed value for this field descriptor, so that in particular on the basis of digital signatures (S) an automated carrying out of transactions or conclusion of contracts is made possible.

2. Digital document (D), in particular a contract, according to claim 1,
characterized in that,
further fields are provided for the indication of the legal statuses of the contracting parties (A, B), for the indication of contractual rights and duties of the contracting parties, for the indication of payment methods, for the indication of duties to deliver up or safe keeping and/or for the indication of circumstances attendant upon the contract.

3. Digital document (D), in particular a contract, according to claim 2,
characterized in that,
the fields for the indication of circumstances attendant upon the contract include a field for the indication of further documents or information related to the coming into existence of the digital document.

4. Digital document (D), in particular a contract, having a digital document format in accordance with claim 2 or 3,
characterized in that,
the field for the indication of the contractual rights and duties includes a list of the contractual rights and duties of the contracting parties (A, B) or contains a reference to a further document which contains these indications.

5. Digital document (D), in particular a contract, according to claim 4,
characterized in that,
the field for the indication of documents or data related to the coming into existence of the document contains a list of the documents which contains these indications or includes a unambiguous reference to documents which contain these indications.

6. Digital document (D), in particular a contract, according to claim 4 or 5,
characterized in that,
each digital signature (S) is certified by means of a certificate (Z), whereby each certificate contains a policy or a reference to a policy stating consequences for the non-fulfillment of the conditions agreed in the document.

7. Digital document (D), in particular a contract, according to claim 6,
characterized in that,
in each case there is provided a field for the indication of an identity feature for each contracting party (A, B), whereby each such field contains a public digital signature test key of the contracting party concerned with an indication of the associated certificate.

8. Digital document (D), in particular a contract, according to claim 6 or 7,
characterized in that,
the policy defines the circumstances under which the legal (non-pseudonymous) identities of the contracting parties (A, B) are to be revealed.

9. Digital document (D) in particular a contract, according to claim 8,
characterized in that,
the policy contains a reference to a (or possibly a plurality of) third party or third parties (C), which upon the occurrence of the corresponding circumstances reveals or reveal the identity of one contracting party (A) for the other contracting party (B).

10. Digital document (D), in particular a contract, according to claim 8 or 9,
characterized in that,
the policy defines the circumstances for the fulfillment of open responsibilities or for the provision of equal-valued substitute performances.

11. Digital document (D) in particular a contract, according to claim 10,
characterized in that,
the policy contains a reference to a (or if applicable a plurality of) third party or third parties, which upon occurrence of corresponding circumstances fulfils or fulfil the open responsibilities of a contracting party vis-a-vis another contracting party or provides equal-valued substitute performances.

12. Digital document, in particular contract, according to any of claims 8 to 11,
characterized in that,
the policy contains the indication of a document format so that the certificate (Z) is only valid when the digital document complies with the indicated document format.

13. Digital document (D), in particular a contract, according to claim 12,
characterized in that,
the indication of the document format contains a format description which defines the standardized fields of the document format and provides them with an unambiguous significance.

14. Digital document (D), in particular a contract, according to claim 13,
characterized in that,
the format description defines a field with a reference to further format descriptions, which define further valid fields for the document format.

15. Data processing device (P), in particular a proxy server, for assuming witness function in the automated carrying through of transactions or conclusion of contracts between contracting parties (A, B) in a communications network (I), whereby the data processing device is configured for the automated receipt, intermediate storage and passing on of digital documents (D) according to any of claims 1 to 14.

16. Data processing device (P), in particular a proxy server, in accordance with claim 15,
characterized in that,
received documents (D) are provided with a time stamp before they are intermediately stored or passed on.

17. Data processing device (P), in particular a proxy server, according to claim 15 or 16,
characterized in that,
received documents (D) are digitally signed.

18. Data processing device (P), in particular a proxy server, in accordance with claim 17,
characterized in that,
a document (D) received from one contracting party (A) is digitally signed, passed on to the other contracting party (B) and intermediately stored at least until reception of confirmation of receipt.

19. Data processing device (P), in particular a proxy server, in accordance with 15 or 16,
characterized in that,
a document (D) received from one contracting party (A) and provided with a digital signature (S) is passed on to the other contracting party (B) without the digital signature, whereby only after receipt of the document from the other contracting party, together with digital signature (S), is the document (D) digitally signed by the one (A) and by the other (B) contracting party sent back to the two contracting parties (A, B). For this data processing device the name “E-Witness” or “Online-Witness” or “Online-Zeuge” is claimed.

20. Data processing device (C) for assuming guarantee functions in automated transactions or conclusions of contracts between contracting parties (A, B) with the employment of digital documents (D) in accordance with any of claims 1 to 14 in a communications network (I), whereby in dependence upon conditions laid down in a digital document (D) guaranteed performances are provided.

21. Data processing device (C) for assuming guarantee functions in accordance with claim 20,
characterized by
a certification mechanism for the issue of certificates (Z) of identities, whereby each certificate contains a policy or a reference to a policy setting out consequences for the non-fulfillment of responsibilities agreed in a contract.

22. Data processing device (C) for assuming guarantee functions in accordance with claim 20 or 21,
characterized by
an identity administration mechanism for the administration of pseudonymous and non-pseudonymous identities of contracting parties (A, B).

23. Data processing device (C) for assuming guarantee functions in accordance with claim 22,
characterized in that,
the identity administration mechanism discloses the legal (non-pseudonymous) identity of a contracting party (A), in dependence upon the non-fulfillment of responsibilities laid down in a contract, with respect to the other contracting party (B) or a third party.

24. Data processing device (C) for assuming guarantee functions in accordance with claim 22,
characterized in that,
the identity administration mechanism guarantees, for a pseudonymous identity of a contracting party (A), the contractually agreed payment of a particular sum of money with respect to the other contracting party (B).

25. Data processing device (C) for assuming guarantee functions in accordance with claim 24,
characterized in that,
the identity administration mechanism, instead of the indication of an identity for a contracting party, signs for the presence of a particular sum of money in a contract.

26. Computer software for automated transactions or conclusions of contracts between contracting parties (A, B) in a communications network (I) on the basis of digital documents according to any of claims 1 to 14, whereby the computer software, when it is installed on a data processing device of the communications network (I), automatically generates such digital documents, if applicable signs them, and sends them to a contracting party.

27. Computer software according the claim 26,
characterized in that,
it automatically checks a document (D) received from a contracting party (A), if appropriate alters the document, and sends it back to the contracting party (B).

28. Computer software according the claim 26 or 27,
characterized in that,
it makes possible the dynamic administration of identity attributes, kinds of identification and further attributes, which relate to a person, if applicable with a qualified certificate.

29. Computer software according the claim 26, 27 or 28,
characterized in that,
it makes possible the administration of personal profiles made available to third parties.

30. Computer software according to any of claims 26 to 29,
characterized in that,
it locally collects and administers a shopping basket for routine purchases on the basis of the documents or contracts according to claims 1 to 14.
